(19) United States
(12) Patent Application Publication
(10) Pub. No.: US 2017/0280066 A1
(43) Pub. Date: Sep. 28, 2017

(54) IMAGE PROCESSING METHOD BY IMAGE PROCESSING APPARATUS

(71) Applicant: CASIO COMPUTER CO., LTD., Tokyo (JP)

(72) Inventor: Tetsuya HAYASHI, Hanno-shi (JP)

(73) Assignee: CASIO COMPUTER CO., LTD., Tokyo (JP)

(21) Appl. No.: 15/373,435

(22) Filed: Dec. 8, 2016

(30) Foreign Application Priority Data
Mar. 23, 2016 (JP) 2016-057930

(51) Int. Cl. H04N 5/272; G11B 27/036; H04N 9/04; H04N 5/343; H04N 5/232; H04N 5/243

(52) U.S. Cl. CPC H04N 5/272; H04N 5/23232; H04N 5/23296; H04N 5/23212; H04N 5/243; H04N 9/045; H04N 5/343; G11B 27/036

(57) ABSTRACT

An image processing method by an image processing apparatus, including: acquiring a first image which is a first area of a subject displayed with first resolving power; acquiring a second image which is a second area smaller than the first area of the subject, displayed with second resolving power higher than the first resolving power; and generating a third image by compositing the first image and the second image with the first resolving power and the second resolving power remaining.

### BACKGROUND OF THE INVENTION

1. Field of the Invention

The present invention relates to an image processing apparatus that generates a composite image.

2. Description of the Related Art

Conventionally, a technique has been known that composites an image including the entirety of a subject reduced and an image including a portion of the subject enlarged and displays so that both of the entirety and a detail of the subject can be simultaneously ascertained on one monitor screen during shooting (for example, refer to JP 2002-162681 A).

### SUMMARY OF THE INVENTION

One aspect of the present invention is summarized as an image processing method by an image processing apparatus, including: acquiring a first image which is a first area of a subject displayed with first resolving power; acquiring a second image which is a second area smaller than the first area of the subject, displayed with second resolving power higher than the first resolving power; and generating a third image by compositing the first image and the second image with the first resolving power and the second resolving power remaining.

Another aspect of the present invention is summarized as an image processing apparatus comprising: a control unit configured to: acquire a first image which is a first area of a subject displayed with first resolving power; acquire a second image which is a second area smaller than the first area of the subject, displayed with second resolving power higher than the first resolving power; and composite the first image and the second image with the first resolving power and the second resolving power remaining so as to generate a third image.

### BRIEF DESCRIPTION OF THE DRAWING

FIG. 1 is a block diagram of a schematic configuration of an image capturing apparatus according to a first embodiment to which the present invention has been applied;

FIG. 2 is a flow chart of exemplary operation according to video shooting processing performed by the image capturing apparatus in FIG. 1;

FIGS. 3A to 3D are views for describing the video shooting processing in FIG. 2;

FIG. 4 is a flow chart of exemplary operation according to playback processing performed by the image capturing apparatus in FIG. 1;

FIGS. 5A to 5C are views for describing the playback processing in FIG. 4;

FIG. 6 is a block diagram of a schematic configuration of an image capturing apparatus according to a second embodiment to which the present invention has been applied;

FIG. 7 is a flow chart of exemplary operation according to video shooting processing performed by the image capturing apparatus in FIG. 6;

FIG. 8 is a flow chart of exemplary operation according to playback processing performed by the image capturing apparatus in FIG. 6; and

FIGS. 9A to 9D are views for describing the playback processing in FIG. 8.

### DETAILED DESCRIPTION OF THE PREFERRED EMBODIMENTS

Specific embodiments of the present invention will be described below with the drawings. Note that, the scope of the invention is not limited to the illustrated examples.

### First Embodiment

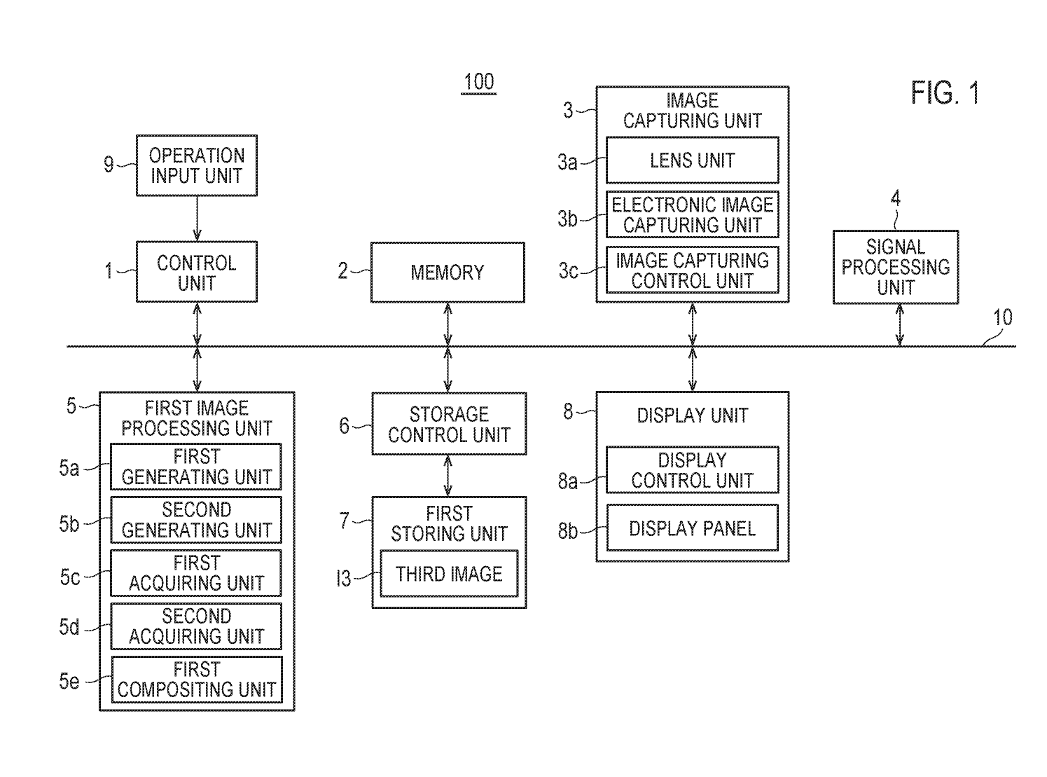

FIG. 1 is a block diagram of a schematic configuration of an image capturing apparatus 100 according to a first embodiment to which the present invention has been applied.

As illustrated in FIG. 1, the image capturing apparatus 100 according to the first embodiment specifically includes a control unit 1, a memory 2, an image capturing unit 3, a signal processing unit 4, a first image processing unit 5, a storage control unit 6, a first storing unit 7, a display unit 8, and an operation input unit 9.

The control unit 1, the memory 2, the image capturing unit 3, the signal processing unit 4, the first image processing unit 5, the storage control unit 6, and the display unit 8 are coupled through a bus line 10.

The control unit 1 controls each unit of the image capturing apparatus 100. Specifically, the control unit 1 includes, for example, a central processing unit (CPU) not illustrated, and performs varieties of control operation in accordance with various processing programs for the image capturing apparatus 100 (not illustrated).

The memory 2 includes, for example, dynamic random access memory (DRAM), and temporarily stores data to which the control unit 1 and the first image processing unit 5 perform processing.

The image capturing unit 3 captures an image of a subject at an arbitrary image capturing frame rate so as to generate frame images. Specifically, the image capturing unit 3 includes a lens unit 3a, an electronic image capturing unit 3b, and an image capturing control unit 3c.

The lens unit 3a includes a plurality of lenses, such as a zoom lens and a focus lens, and an aperture that adjusts the amount of light that passes through the lenses.

The electronic image capturing unit 3b includes an image sensor (an image capturing element), such as a charge coupled device (CCD) or a complementary metal-oxide semiconductor (CMOS). The electronic image capturing unit 3b converts an optical image that has passed through the various lenses of the lens unit 3a, into a two-dimensional image signal.

The image capturing control unit 3c, for example, uses a timing generator or a driver so as to scan and drive the electronic image capturing unit 3b, uses the electronic image capturing unit 3b so as to convert the optical image that has passed through the lens unit 3a, into the two-dimensional image signal in a predetermined cycle, reads a frame image one screen by one screen from an image capturing region of the electronic image capturing unit 3b, and outputs the read frame image to the signal processing unit 4.

Note that, the image capturing control unit 3c may perform adjustment control of conditions in capturing the image of the subject, such as automatic focus processing (AF), automatic exposure processing (AE), and automatic white balance (AWB).

The signal processing unit 4 performs varieties of image signal processing to an analog value of the frame image transmitted from the electronic image capturing unit 3b. Specifically, the signal processing unit 4, for example, appropriately performs gain control to a signal of the analog value of the frame image for each color component of RGB, uses a sample-and-hold circuit (not illustrated) so as to sample and hold the controlled signal, uses an A/D converter (not illustrated) so as to convert the sampled and held signal into digital data, uses a color process circuit (not illustrated) so as to perform color process processing including pixel interpolation processing and γ correction processing to the digital data, and generates a luminance signal Y and color difference signals Cb and Cr (YUV data) of a digital value. The signal processing unit 4 also outputs the generated luminance signal Y and color difference signals Cb and Cr, to the memory 2 used for a buffer memory.

The first image processing unit 5 includes a first generating unit 5a, a second generating unit 5b, a first acquiring unit 5c, a second acquiring unit 5d, and a first compositing unit 5e.

Note that, each of the units of the first image processing unit 5 includes, for example, a predetermined logic circuit. However, the configuration is exemplary and the embodiment of the present invention is not limited to this.

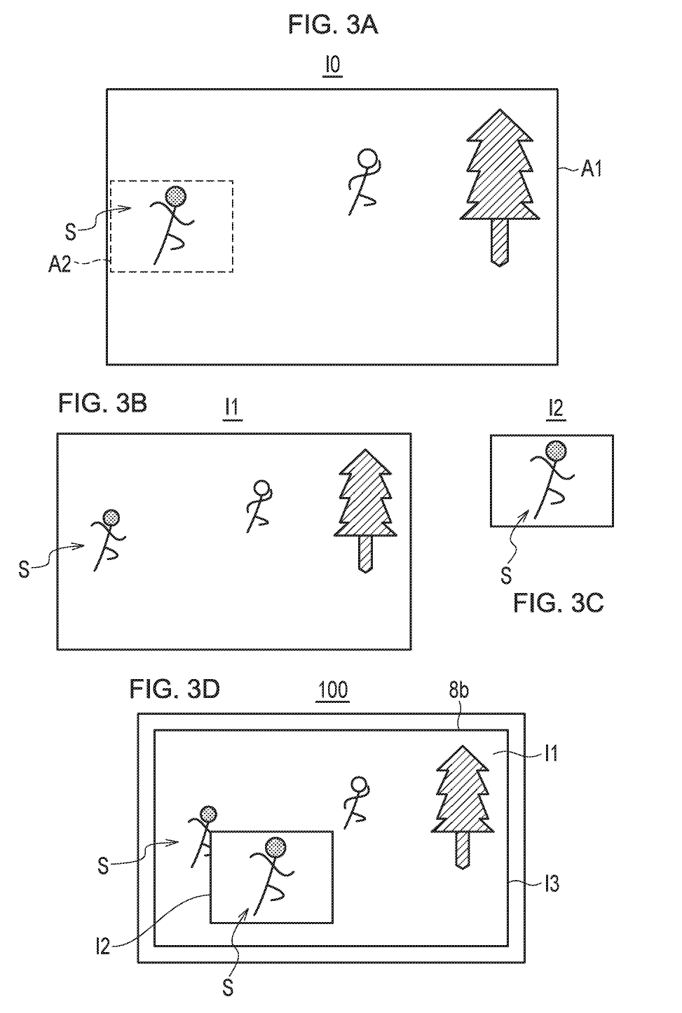

The first generating unit 5a generates a first image I1 which is a first area A1 of the subject displayed with first resolving power (refer to FIG. 3B).

That is, the first generating unit (a first generating means) 5a reduces the entirety of an original image I0 captured by the image capturing unit 3 (refer to FIG. 3A) as the first area A1 so as to generate the first image I1.

Specifically, the image capturing unit (an image capturing means) 3 captures an image of the entirety of an area that can be shot, in the subject with predetermined resolution using all pixels effective for image capture of the image capturing region of the electronic image capturing unit 3b (for example, width×height: 2560×1440). The signal processing unit 4 performs the varieties of image signal processing to a signal of an analog value transmitted from the electronic image capturing unit 3b so as to generate YUV data of the original image I0. The first generating unit 5a acquires reproduction of the generated YUV data of the original image I0, and generates YUV data of the first image I1 having a predetermined number of pixels (for example, width×height: 1920×1080), displayed with the first resolving power after reduction of the entire original image I0 (the first area A1) by, for example, thinning processing.

Here, the first resolving power and second resolving power to be described later relatively represent the degree of fineness of an object in an image (for example, a specific subject S to be described later). For example, the number of pixels has been a criterion, but is exemplary. The embodiment of the present is not limited to this. Image formation performance of the lens unit 3a or the compression ratio of an image may be used as the criterion. For example, a modulation transfer function (MTF) curve representing spatial frequency characteristics of a lens, can be used as the image formation performance of the lens unit 3a. When the image formation performance of the lens unit 3a relatively increases, resolving power accordingly increases. For example, in a case where compression is made in a JPEG format, image quality varies in accordance with the compression ratio. Thus, when the compression ratio relatively decreases, resolving power accordingly increases.

In a case where the image capturing unit 3 captures a moving image of the subject, the first generating unit 5a individually sets a plurality of frame images included in the moving image to be the original image I0, and performs the above same processing so as to generate YUV data of the first image I1, individually.

The second generating unit 5b generates a second image I2 which is a second area A2 of the subject displayed with the second resolving power (refer to FIG. 3C).

That is, the second generating unit (a second generating means) 5b cuts out a region of a portion of the original image I0 captured by the image capturing unit 3 (refer to FIG. 3A) as the second area A2 so as to generates the second image I2. In this case, the second generating unit 5b generates the second image I2 from the original image I0 the same as an image (the original image I0) used for the generation of the first image I1 by the first generating unit 5a.

Specifically, the second generating unit 5b acquires reproduction of the YUV data of the original image I0 generated by the signal processing unit 4, and cuts out, as the second area A2, a region including the specific subject S present in the original image I0 (a notice portion), detected by performing, for example, predetermined subject detection processing (for example, face detection processing). Thus, the second generating unit 5b generates YUV data of the second image I2 including the specific subject S displayed with the second resolving power.

That is, the second area A2 being the size of the second image I2, is the region of the portion of the original image I0. Thus, the second area A2 is smaller than the first area A1 in size. When the number of pixels included in the specific subject S in the second image I2 and the number of pixels included in the specific subject S in the first image I1 are compared, the number of pixels included in the specific subject S in the second image I2 is larger. Thus, the second resolving power of the second image I2 is higher than the first resolving power.

In a case where the image capturing unit 3 captures the moving image of the subject, the second generating unit 5b individually sets the plurality of frame images included in the moving image to be the original image I0, and performs the above same processing so as to generate YUV data of the second image I2, individually. In this case, the second generating unit 5b may vary the size of the second area A2 to be cut out for each of the plurality of frame images included in the moving image and generate the second image I2, individually. For example, the second generating unit 5b may generate a plurality of the second images I2, gradually enlarging the size of the second area A2 in accordance with the passage of time for the plurality of frame images.

In this manner, the first generating unit 5a and the second generating unit 5b generate the first image I1 and the second image I2 from the same original image I0 captured with the predetermined resolution by the image capturing unit 3, respectively.

Note that, the face detection processing is a publicly known technique and the detailed descriptions thereof will be omitted here. The face detection processing has been exemplified as the subject detection processing, but is exemplary. The embodiment of the present invention is not limited to this. For example, the face detection processing can be appropriately, arbitrarily changed to any processing that uses a predetermined image recognition technique, such as edge detection processing or feature extraction processing.

The first acquiring unit 5c acquires the first image I1.

That is, the first acquiring unit (a first acquiring means) 5c acquires the first image I1 which is the first area A1 of the subject displayed with the first resolving power (refer to FIG. 3B). Specifically, the first acquiring unit 5c individually acquires the YUV data of the first image I1 generated by the first generating unit 5a with each of the plurality of frame images included in the moving image as the original image I0.

The second acquiring unit 5d acquires the second image I2.

That is, the second acquiring unit (a second acquiring means) 5d acquires the second image I2 which is the second area A2 smaller than the first area A1 of the subject, displayed with the second resolving power higher than the first resolving power (refer to FIG. 3C). Specifically, the second acquiring unit 5d individually acquires the YUV data of the second image I2 generated by the second generating unit 5b with each of the plurality of frame images included in the moving image as the original image I0.

The first compositing unit 5e generates a third image I3 (refer to FIG. 3D).

That is, the first compositing unit (a compositing means) 5e composites the first image I1 acquired by the first acquiring unit 5c and the second image I2 acquired by the second acquiring unit 5d with the respective pieces of resolving power remaining, so as to generate the third image I3. Specifically, during the shooting of the subject, the first compositing unit 5e performs composition so as to superimpose an image (for example, the second image I2) present on the outer side in a composition state, on a position at which no specific subject S is present or a composition position set at an arbitrary position based on predetermined operation performed by a user, in an image (for example, the first image I1) present on the inner side in the composition state, with the pieces of resolving power of the first image I1 and the second image I2 remaining. Thus, the first compositing unit 5e generates YUV data of the third image I3 including the respective pieces of resolving power of the first image I1 and the second image I2 remaining.

In a case where the image capturing unit 3 captures the moving image of the subject, the first compositing unit 5e composites the first image I1 and the second image I2 corresponding to each other for each of the plurality of frame images included in the moving image so as to generate the third image I3, individually. In this case, the first compositing unit 5e may perform the composition with the size of each of the first image I1 and the second image I2 varying.

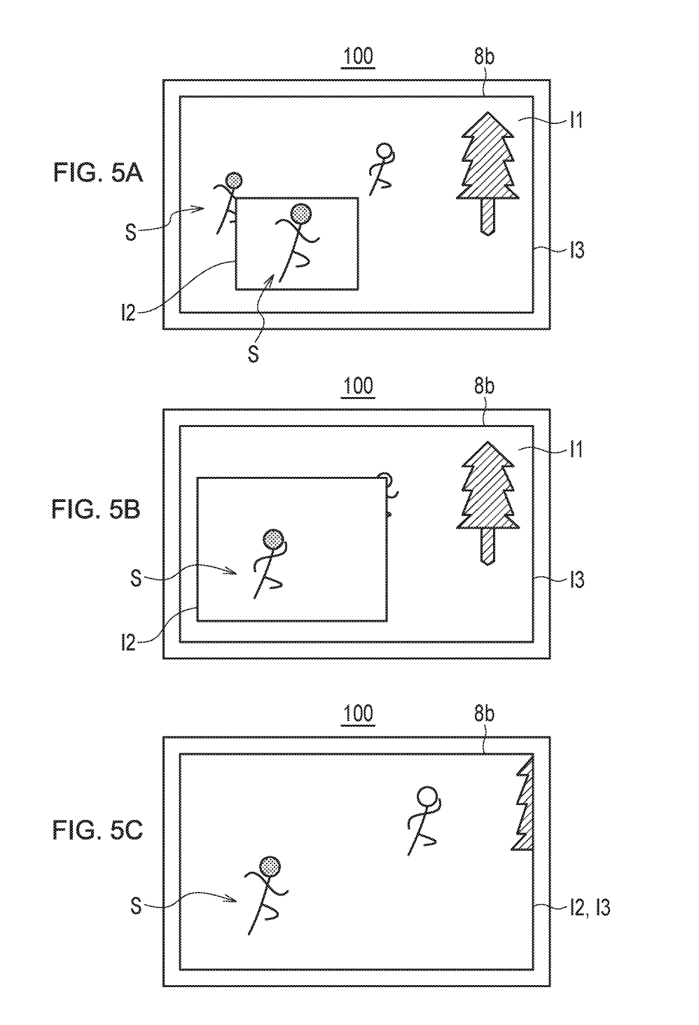

For example, the first compositing unit 5e sets the first image I1 and the second image I2 to be on the inner side and on the outer side, respectively, and composites the second image I2 generated by the second generating unit 5b with the size of the second area A2 gradually enlarging in accordance with the passage of time, with the first image I1 (refer to FIGS. 5A to 5C).

Note that, the composition of the first image I1 and the second image I2 is a publicly known technique, and the detailed descriptions thereof will be omitted here.

The storage control unit 6 controls reading of data from the first storing unit 7 and writing of data to the first storing unit 7.

That is, the storage control unit 6 stores image data for storage of a moving image or a still image into the first storing unit 7 including, for example, nonvolatile memory (flash memory) or a storage medium. Specifically, the storage control unit 6 compresses (encodes) the third image I3 generated by the composition of the first image I1 and the second image I2 performed by the first compositing unit 5e, in a predetermined compression format (for example, an MPEG format, an M-JPEG format, or a JPEG format), and then stores the compressed third image I3 into the first storing unit (a first storing means) 7, during the shooting of the subject.

For example, in a case where the image capturing unit 3 captures the moving image of the subject, the storage control unit 6 compresses the third image I3 sequentially generated by the first compositing unit 5e, and temporarily stores the compressed third image I3 into the memory 2 as each of the frame images included in the moving image. When the capturing of the moving image is completed, the storage control unit 6 acquires all of the frame images from the memory 2, associates the frame images as a moving image, and stores (saves) the moving image into the first storing unit 7.

The display unit 8 includes a display control unit 8a and a display panel 8b.

The display control unit 8a controls a predetermined image to be displayed on a display region of the display panel 8b, based on the image data having a predetermined size, decoded by the storage control unit 6 after the reading from the memory 2 and the first storing unit 7. Specifically, the display control unit 8a includes, for example, video random access memory (VRAM), a VRAM controller, and a digital video encoder. The digital video encoder reads the luminance signal Y and the color difference signals Cb and Cr being stored in the VRAM (not illustrated) after the decoding performed by the storage control unit 6, from the VRAM at a predetermined playback frame rate through the VRAM controller, generates a video signal based on the pieces of data, and outputs the video signal to the display panel 8b.

The display panel 8b displays, for example, the image captured by the image capturing unit 3, within the display region, based on the video signal from the display control unit 8a. Specifically, the display panel (a playback means) 8b switches and plays back the third image I3 being stored, as each of the frame images included in the moving image, in the first storing unit 7, at a predetermined playback frame rate. In this case, the display panel 8b plays back, as each of the frame images, the third image I3 including the second image I2 with the size of the second area A2 gradually enlarging, composited, in a case where the moving image including, as the plurality of frame images, a plurality of the third images I3 generated by the first compositing unit 5e with a plurality of the second images I2 generated with the size of the second area A2 gradually enlarging, is made to be an object to be played back (refer to FIGS. 5A to 5C).

Note that, examples of the display panel 8b include a liquid crystal display panel and an organic electro-luminescence (EL) display panel. However, the display panels are exemplary, and the embodiment of the present invention is not limited to these.

The operation input unit 9 performs predetermined operation of the image capturing apparatus 100. Specifically, the operation input unit 9 includes operating units, such as a shutter button according to an instruction for capturing the image of the subject, a selection determining button according to an instruction for selecting an image capturing mode or performance, and a zoom button according to an instruction for adjusting the amount of zooming (any not illustrated).

When the user operates any of the various buttons, the operation input unit 9 outputs an operating signal in response to the operated button, to the control unit 1. The control unit 1 makes each of the units to perform predetermined operation (for example, shooting of a moving image), in accordance with an operating instruction output from the operation input unit 9 and input to the control unit 1.

### <Video Shooting Processing>

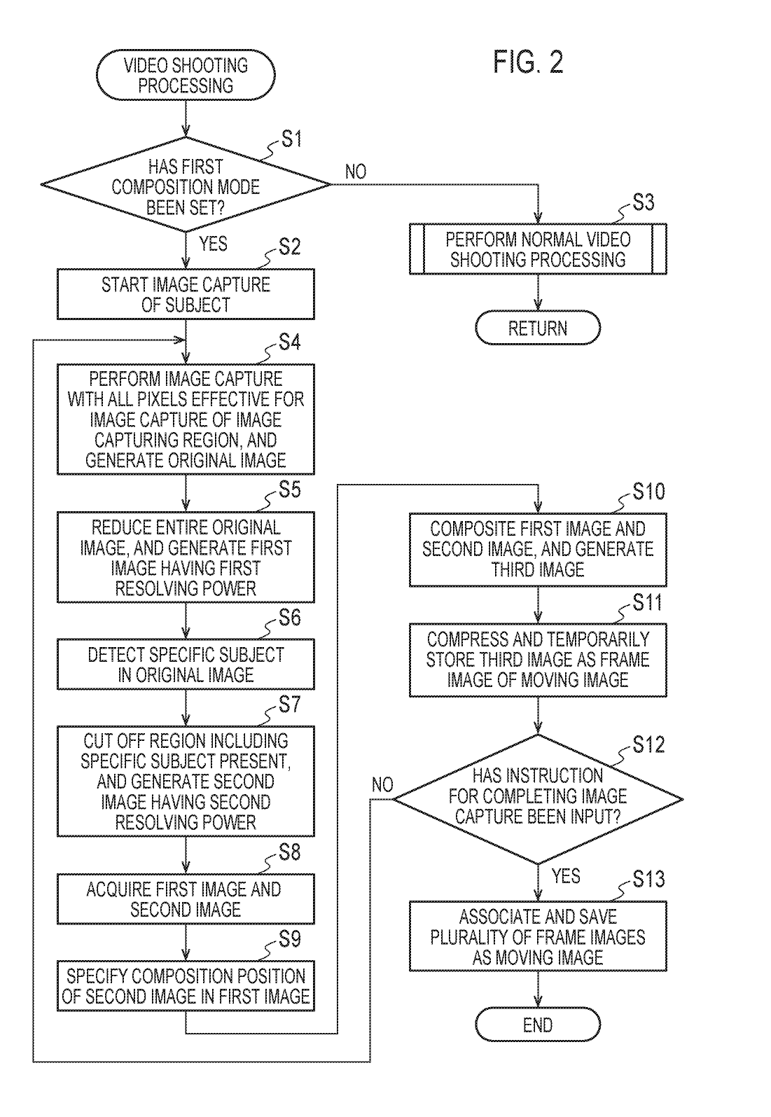

Next, video shooting processing performed by the image capturing apparatus 100, will be described with reference to FIGS. 2 to 3D.

FIG. 2 is a flow chart of exemplary operation according to the video shooting processing. FIGS. 3A to 3D are views for describing the video shooting processing, and schematically illustrate one frame image included in the moving image.

As illustrated in FIG. 2, first, the CPU of the control unit 1 determines whether a first composition mode in which the third image I3 including the first image I1 and the second image I2 composited, is a frame image included in the moving image, has been set, for example, based on the predetermined operation of the operation input unit 9 by the user (step S1).

Here, when the CPU of the control unit 1 determines that the first composition mode has been set (step S1: YES), the image capturing unit 3 starts capturing the moving image of the subject, based on the predetermined operation of the operation input unit 9, performed by the user (for example, the shutter button) (step S2).

Meanwhile, when determining that the first composition mode has not been set (step S1: NO), the CPU of the control unit 1 performs normal video shooting processing in which the image generated by the capturing of the image of the subject performed by the image capturing unit 3 is the frame image included in the moving image (step S3).

When the capturing of the moving image of the subject starts (step S2), the image capturing control unit 3c of the image capturing unit 3 captures the image of the entire area that can be shot, in the subject, with all the pixels effective for the image capture of the image capturing region of the electronic image capturing unit 3b (for example, width×height: 2560×1440) with predetermined image capturing timing in accordance with the image capturing frame rate of the moving image. The image capturing control unit 3c of the image capturing unit 3 converts the optical image into the two-dimensional image signal and outputs the image signal to the signal processing unit 4. The signal processing unit 4 performs the varieties of image signal processing to the signal of the analog value transmitted from the electronic image capturing unit 3b so as to generate the YUV data of the original image I0 (step S4, refer to FIG. 3A).

The first generating unit 5a acquires the reproduction of the YUV data of the original image I0 generated by the signal processing unit 4, and generates the YUV data of the first image I1 having the predetermined number of pixels (for example, width×height: 1920×1080), displayed with the first resolving power after the reduction of the entire original image I0 by, for example, the thinning processing (step S5, refer to FIG. 3B).

Next, the second generating unit 5b acquires the reproduction of the YUV data of the original image I0 generated by the signal processing unit 4, and performs, for example, the predetermined subject detection processing (for example, face detection processing) so as to detect the specific subject S from the inside of the original image I0 (step S6). Sequentially, the second generating unit 5b cuts out, as the second are A2, the region including the detected specific subject S present, so as to generate the YUV data of the second image I2 including the specific subject S displayed with the second resolving power (step S7, refer to FIG. 3C).

Note that, the region including the specific subject S present, to be cut out as the second area A2, may be designated, for example, based on the predetermined operation of the operation input unit 9 performed by the user.

The above order of the respective pieces of processing at steps S5 to S7 is exemplary and the embodiment of the present invention is not limited to this. For example, the first image I1 may be generated after the generation of the second image I2.

The first acquiring unit 5c acquires the YUV data of the first image I1 generated by the first generating unit 5a and additionally the second acquiring unit 5d acquires the YUV data of the second image I2 generated by the second generating unit 5b (step S8).

Next, the first compositing unit 5e specifies a composition position of the second image I2 present on the outer side in the first image I1 present on the inner side in the composition state (step S9). Specifically, the first compositing unit 5e specifies, as the composition position, for example, a position at which no specific subject S is present in the first image I1, an arbitrary position set based on the predetermined operation of the operation input unit 9 performed by the user, or a position designated as a default.

Sequentially, the first compositing unit 5e composites the second image I2 to be superimposed on the composition position specified in the first image I1 and then generates the YUV data of the third image I3 (step S10, refer to FIG. 3D). Note that, FIG. 3D schematically illustrates a state where the generated third image I3 has been displayed as a live view image on the display panel 8b.

After that, the storage control unit 6 acquires the YUV data of the third image I3 generated by the first compositing unit 5e, compresses the YUV data of the third image I3 in the predetermined compression format (for example, an MPEG format), and temporarily stores, as the frame image included in the moving image, the compressed YUV data into the memory 2 (step S11).

Next, the CPU of the control unit 1 determines whether an instruction for completing the capturing of the moving image of the subject has been input (step S12). Here, for example, the completion of the capturing of the moving image of the subject is instructed based on the predetermined operation of the operation input unit 9 performed by the user or is instructed based on the passage of recording time that has been previously designated.

At step S12, when determining that the instruction for completing the capturing of the moving image of the subject has not been input (step S12: NO), the CPU of the control unit 1 makes the processing go back to step S4 and successively performs the respective pieces of processing from step S4. That is, the CPU of the control unit 1 performs the respective pieces of processing at steps S4 to S11 so that a third image I3 to be a next frame image included in the moving image is generated and is stored into the memory 2.

The CPU of the control unit 1 repeatedly performs the above respective pieces of processing until determining that the instruction for completing the capturing of the moving image of the subject has been input, at step S12 (step S12: YES).

Meanwhile, when the CPU of the control unit 1 determines that the instruction for completing the capturing of the moving image of the object has been input, at step S12 (step S12: YES), the storage control unit 6 acquires all of the frame images temporarily stored in the memory 2, associates the frame images as a moving image, and saves the moving image into the first storing unit 7 (step S13).

Accordingly, the video shooting processing is completed.

### <Playback Processing>

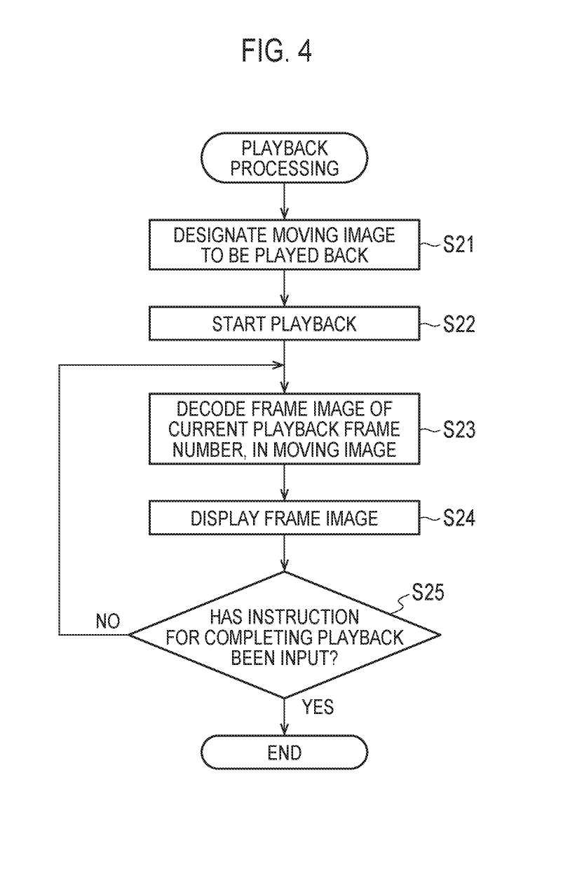

Next, playback processing performed by the image capturing apparatus 100 will be described with reference to FIGS. 4 to 5C.

FIG. 4 is a flow chart of exemplary operation according to the playback processing. FIGS. 5A to 5C are views for describing the playback processing.

As illustrated in FIG. 4, when the moving image to be played back is designated, for example, based on the predetermined operation of the operation input unit 9 performed by the user (step S21), the display unit 8 starts playing back the designated moving image (step S22).

That is, the storage control unit 6 reads the data of the moving image to be played back from the first storing unit 7, uses a decoding method corresponding to the compression format (for example, an MPEG format) so as to decode the third image I3 being the frame image corresponding to a current playback frame number, out of the plurality of frame images included in the moving image, and outputs the decoded third image I3 to the display control unit 8a (step S23). The display control unit 8a displays, as the frame image, the input third image I3 on the display region of the display panel 8b at the predetermined playback frame rate (step S24, refer to FIG. 5A).

Next, the CPU of the control unit 1 determines whether an instruction for completing the playback of the moving image has been input (step S25). Here, the completion of the playback of the moving image is instructed, for example, based on the passage of playback time of the moving image to be played back, or is instructed based on the predetermined operation of the operation input unit 9 performed by the user even during the playback.

When determining that the instruction for completing the playback of the moving image has not been input, at step S25 (step S25: NO), the CPU of the control unit 1 makes the processing go back to step S23 and successively performs the respective pieces of processing from step S23. That is, the CPU of the control unit 1 performs the respective pieces of processing at steps S23 and S24 so that a frame image corresponding to a current playback frame number (a next frame number when the previous frame number is defined as a base) is displayed, out of the plurality of frame images included in the moving image (refer to FIGS. 5B and 5C).

Here, FIGS. 5A to 5C illustrate the exemplary moving image including, as a frame image, the third image I3 including the second image I2 generated with the second area A2 gradually enlarging in accordance with the passage of the image capturing time of the moving image, and the first image I1 composited, when the first image I1 is present on the outer side and the second image I2 is present on the inner side. As illustrated in FIG. 5C, when the size of the second image I2 becomes substantially the same as the size of the first image I1, the second image I2 is displayed over the entire display panel 8b.

The CPU of the control unit 1 repeatedly performs the above respective pieces of processing until determining that the instruction for completing the playback of the moving image has been input, at step S25 (step S25: YES).

When determining that the instruction for completing the playback of the moving image has been input, at step S25 (step S25: YES), the CPU of the control unit 1 completes the playback.

As described above, the image capturing apparatus 100 according to the first embodiment, acquires the first image I1 which is the first area A1 of the subject displayed with the first resolving power, acquires the second image I2 which is the second area A2 smaller than the first area A1 of the subject, displayed with the second resolving power higher than the first resolving power, and composites the acquired first image I1 and second image I2 with the respective pieces of resolving power remaining so as to generate the third image I3. Differently from a case where composition and display are performed with a region of a portion of the first image I1 simply enlarged, for example, the image capturing apparatus 100 composites, as the second image I2 having higher resolving power, the second area A2 specified corresponding to the specific subject S with the first image I1 so as to be able to generate the third image I3. Thus, the composite third image I3 can be effectively utilized in the storage and the playback of the third image I3.

The image capturing apparatus 100 captures the image of the entire area that can be shot, in the subject, with the predetermined resolution, reduces the entire captured original image I0 as the first area A1, generates the first image I1, cuts out the region of the portion of the original image I0 (the notice portion) as the second area A2, and then generates the second image I2. Thus, the generation of the first image I1 and the second image I2 each having different resolving power, can be easily performed. As a result, the generation of the third image I3 can be easily performed by the acquisition of the images. Particularly, the first image I1 and the second image I2 each having the different resolving power can be individually generated from the same original image I0 captured with the predetermined resolution.

The entire captured original image I0 is reduced and then is stored with the notice portion in the original image I0 not reduced. Thus, even when small storage capacity is provided, the shot image can be stored in a form in which approximate ascertainment of the entirety and detailed ascertainment of the notice portion can be made.

The storage is made in a state where the second image I2 corresponding to the cut-out notice portion has been composited with a portion of the first image I1 including the entire original image I0 reduced. Thus, no management of storing and playing back two frame images (image files) individually is required. Only one frame image (an image file) is stored and is played back so that the approximate ascertainment of the entirety and the detailed ascertainment of the notice portion can be made.

Furthermore, the first image I1 is generated from each of the plurality of frame images included in the moving image of the subject captured by the image capturing unit 3, and the second image I2 is generated from each of the plurality of frame images. Then, the third image I3 is generated by compositing the first image I1 and the second image I2 corresponding to each other for each of the plurality of frame images. Thus, the moving image including, as each of the frame images, the third image I3 including the first image I1 and the second image I2 each having the different resolving power, composited, can be generated. In this case, the second image I2 is generated with the size of the second area A2 varying for each of the plurality of frame images included in the moving image. The moving image including, as the plurality of frame images, a plurality of the third images I3 generated with a plurality of the generated second images I2, can be played back with the size of the second area A2 gradually enlarging. Thus, the composite third image I3 can be more effectively utilized.

During the shooting of the subject, the third image I3 is generated by compositing the first image I1 and the second image I2, and the first storing unit 7 stores the third image I3. Thus, only reading the third image I3 from the first storing unit 7 can play back the third image I3 including the first image I1 and the second image I2 composited. For example, ascertainment of the specific subject S displayed with the higher resolving power in the second image I2 can be efficiently made.

Furthermore, even when the third image I3 is compressed and then is stored, the respective pieces of resolving power of the first image I1 and the second image I2 can remain.

### Second Embodiment

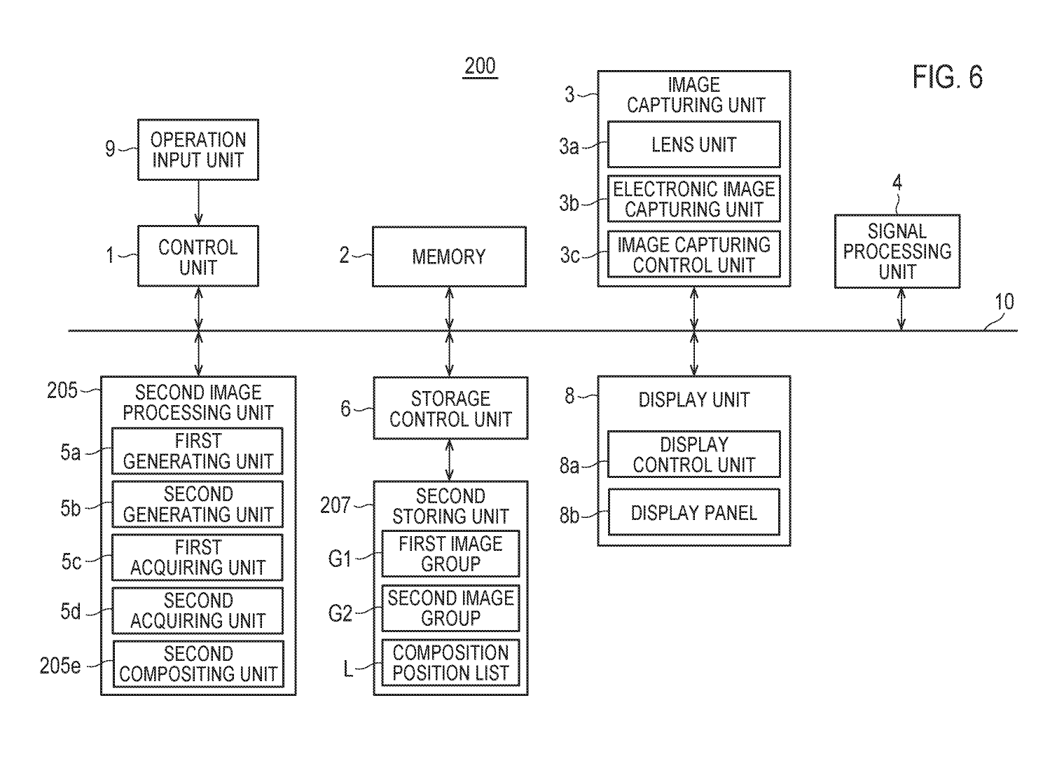

An image capturing apparatus 200 according to a second embodiment will be described below with respect to FIGS. 6 to 9D.

The image capturing apparatus 200 according to the second embodiment has a configuration substantially the same as the configuration of the image capturing apparatus 100 according to the above first embodiment, except detailed descriptions to be given below.

FIG. 6 is a block diagram of the schematic configuration of the image capturing apparatus 200 according to the second embodiment to which the present invention has been applied.

The image capturing apparatus 200 according to the present embodiment, associates a first image I1 generated by a first generating unit 5a and a second image I2 generated by a second generating unit 5b, and stores the associated first image I1 and second image I2 in a second storing unit 207, during shooting of a subject. The image capturing apparatus 200 uses a second compositing unit 205e of a second image processing unit 205 to composite the first image I1 and the second image I2 so as to generate a third image I3, and displays the third image I3, during playback of an image.

First, the second storing unit 207 will be described.

The second storing unit 207 stores a first image group G1, a second image group G2, and a composition position list L.

The first image group G1 includes a plurality of the first images I1 generated by the first generating unit 5a. Specifically, the first image group G1 includes the first images I1 that have been generated by the first generating unit 5a and have been compressed in a predetermined format (for example, an MPEG format) by a storage control unit 6, in association with frame numbers during the shooting of a moving image of the subject.

The second image group G2 includes a plurality of the second images I2 generated by the second generating unit 5b. Specifically, the second image group G2 includes the second images I2 that have been generated by the second generating unit 5b and have been compressed in a predetermined format (for example, an MPEG format) by the storage control unit 6, in association with the frame numbers during the shooting of the moving image of the subject.

The composition position list L includes a composition position of an image present on the outer side (for example, a second image I2) in an image present on the inner side (for example, a first image I1) in a composition state, in association with a frame number.

Note that, the frame numbers represent the order of image capturing frames during the shooting of the moving image of the subject. The frame numbers represent the order of playback frames (playback frame numbers) during playback of the moving image.

The second compositing unit 205e composites a first image I1 and a second image I2 so as to generate a third image I3 during the playback of the image.

That is, the second compositing unit 205e generates a plurality of the third images I3 as a plurality of frame images included in the moving image to be played back. For example, a first acquiring unit 5c acquires YUV data of a first image I1 from the first image group G1 stored in the second storing unit 207 in order to form a third image I3 to be a frame image corresponding to a playback number, during the playback of the image. The second acquiring unit 5d acquires YUV data of a second image I2 from the second image group G2 stored in the second storing unit 207 in order to form the third image I3 to be the frame image corresponding to the playback number. Then, the second compositing unit 205e composites the first image I1 acquired by the first acquiring unit 5c and the second image I2 acquired by the second acquiring unit 5d with pieces of resolving power thereof remaining, so as to generate the third image I3. Specifically, the second compositing unit 205e acquires a composition position in the frame image corresponding to the playback frame number, from the composition position list L stored in the second storing unit 207, composites the image present on the inner side (for example, the second image I2) in the composition state to be superimposed on a composition position of the image present on the outer side (for example, the first image I1) in the composition state, and generates YUV data of the third image I3.

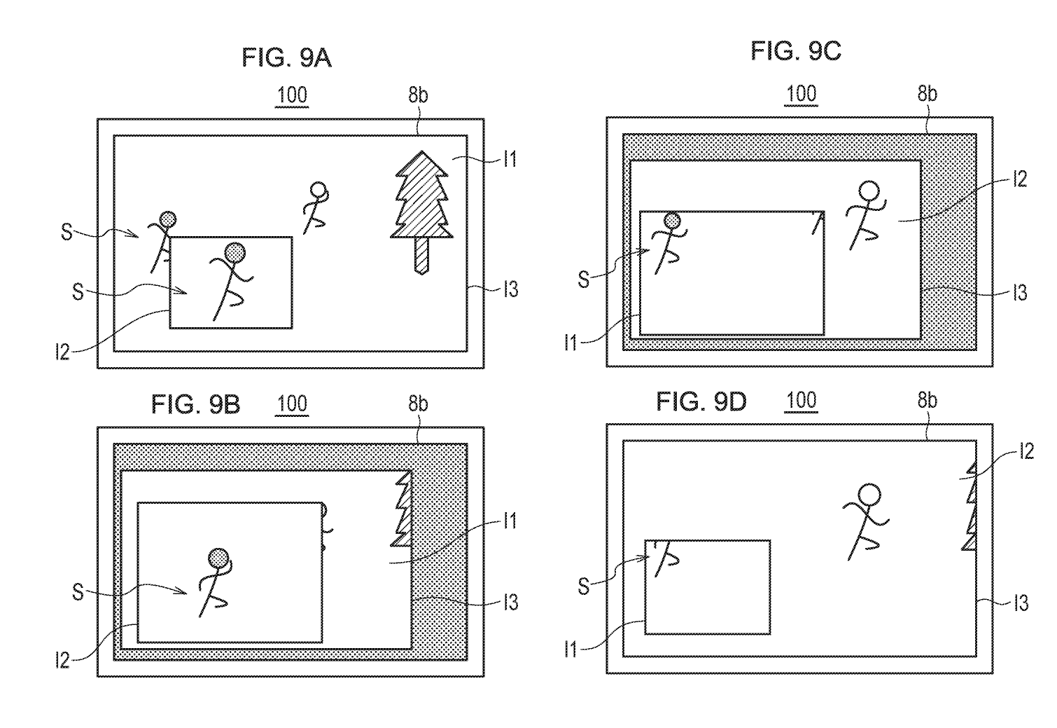

Similarly to the above first embodiment, for example, the second compositing unit 205e may set the first image I1 and the second image I2 to be on the outer side and on the inner side, respectively, and may composite the second image I2 generated by the second generating unit 5b with the size of a second area A2 gradually enlarging in accordance with the passage of time, with the first image I1. In this case, the second compositing unit 205e may gradually reduce the size (the number of pixels) of the first image I1 present on the outer side. When the second image I2 gradually enlarging the size of the second area A2 becomes larger than the size of the first image I1 gradually reducing, the second compositing unit 205e may set the second image I2 and the first image I1 to be on the outer side and on the inner side, respectively, and may composite the first image I1 and the second image I2 so as to generate each of the plurality of the third images I3 (refer to FIGS. 9A to 9D).

Here, the second compositing unit 205e gradually reduces the size of a region of a portion cut out from the first image I1 which is a shot area of the subject largest (for example, a first image I1 corresponding to a first frame number) so as to vary the size of the first image I1.

Note that, the first generating unit 5a and the second generating unit 5b each have a configuration and a function substantially the same as those included in the image capturing apparatus 100 according to the above first embodiment, and the detailed descriptions thereof will be omitted here.

### <Video Shooting Processing>

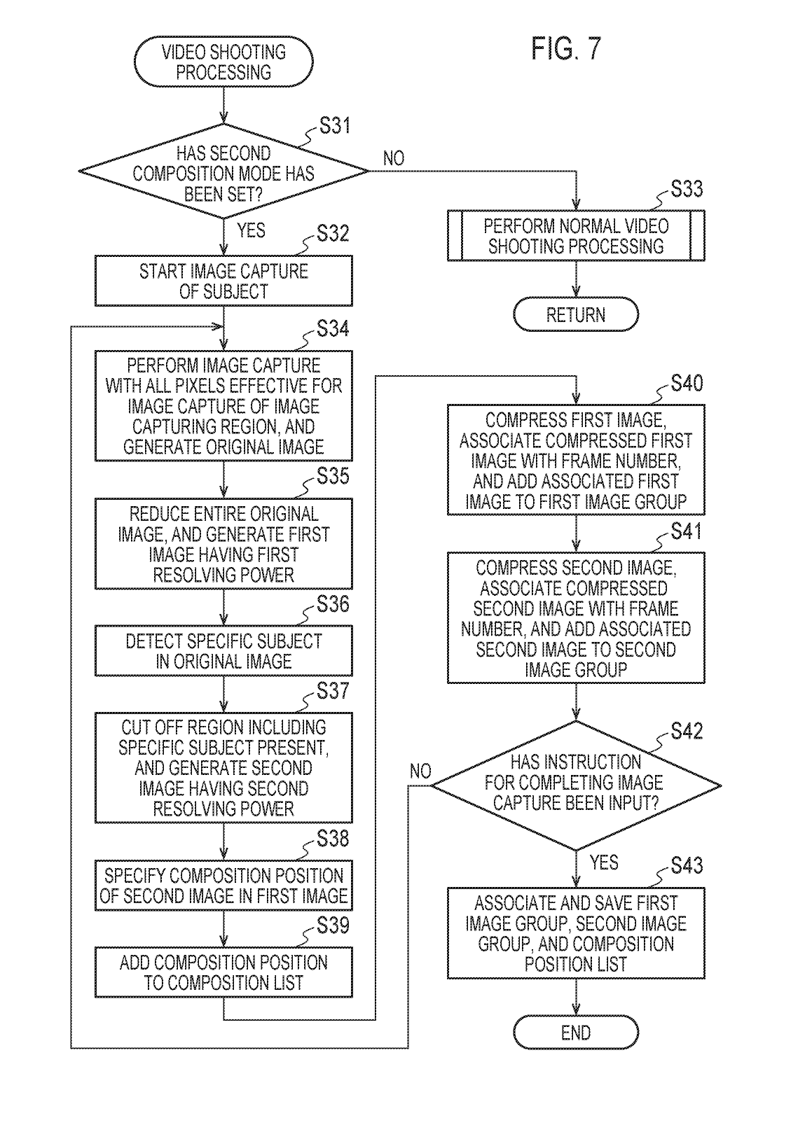

Next, video shooting processing performed by the image capturing apparatus 200 will be described with reference to FIG. 7.

FIG. 7 is a flow chart of exemplary operation according to the video shooting processing.

As illustrated in FIG. 7, first, a CPU of a control unit 1 determines whether a second composition mode in which the third image I3 generated by the composition of the first image I1 and the second image I2 is a frame image included in the moving image during the playback of the image, has been set, for example, based on predetermined operation of an operation input unit 9 performed by a user (step S31).

Here, when the CPU of the control unit 1 determines that the second composition mode has been set (step S31: YES), an image capturing unit 3 starts capturing the moving image of the subject (step S32), substantially, similarly to step S2 in the video shooting processing according to the above first embodiment.

Meanwhile, when determining that the second composition mode has not been set (step S31: NO), the CPU of the control unit 1 performs normal video shooting processing (step S33), substantially, similarly to step S3 in the video shooting processing according to the above first embodiment.

When the capturing of the moving image of the subject starts (step S32), substantially, similarly to step S4 in the video shooting processing according to the above first embodiment, an image capturing control unit 3c of the image capturing unit 3 captures an image of the entirety of an area that can be shot, in the subject, with all pixels effective for image capture of an image capturing region of an electronic image capturing unit 3b (for example, width×height: 2560×1440) with predetermined image capturing timing in accordance with an image capturing frame rate of the moving image. A signal processing unit 4 generates YUV data of an original image I0 (step S34).

The first generating unit 5a generates the YUV data of the first image I1 having a predetermined number of pixels (for example, width×height: 1920×1080) displayed with first resolving power after reduction of the entirety of a reproduced original image I0 (step S35), substantially, similarly to step S5 in the video shooting processing according to the above first embodiment.

Next, the second generating unit 5b detects a specific subject S from the inside of the reproduced original image I0 (step S36), substantially, similarly to step S6 in the video shooting processing according to the above first embodiment, and sequentially cuts out, as the second area A2, a region including the specific subject S present, so as to generate the YUV data of the second image I2 including the specific subject S displayed with second resolving power (step S37), substantially, similarly to step S7 in the video shooting processing according to the above first embodiment.

Then, the second compositing unit 205e specifies the composition position of the second image I2 present on the inner side in the first image I1 present on the outer side in the composition state (step S38), substantially, similarly to step S9 in the video shooting processing according to the above first embodiment. Sequentially, the second compositing unit 205e adds the specified composition position in association with the frame number, into the composition position list L, and then temporarily stores the composition position list L into a memory 2 (step S39).

Next, the storage control unit 6 acquires the YUV data of the first image I1 generated by the first generating unit 5a, compresses the YUV data of the first image I1 in the predetermined compression format (for example, an MPEG format), adds the compressed YUV data in association with the frame number to the first image group G1, and temporarily stores the first image group G1 into the memory 2 (step S40). Sequentially, the storage control unit 6 acquires the YUV data of the second image I2 generated by the second generating unit 5b, compresses the YUV data of the second image I2 in the predetermined compression format (for example, an MPEG format), adds the YUV data of the second image I2 in association with the frame number to the second image group G2, and temporarily stores the second image group G2 into the memory 2 (step S41).

Note that, the above order of the respective pieces of processing at steps S40 and S41 is exemplary and the embodiment of the present invention is not limited to this. For example, the first image I1 may be stored after the storage of the second image I2.

Next, the CPU of the control unit 1 determines whether an instruction for completing the capturing of the moving image has been input (step S42), substantially, similarly to step S12 in the video shooting processing according to the above first embodiment.

Here, when determining that the instruction for completing the capturing of the moving image of the subject has not been input (step S42: NO), the CPU of the control unit 1 makes the processing go back to step S34, and successively performs the respective pieces of processing from step S34. That is, the CPU of the control unit 1 performs the respective pieces of processing at steps S34 to S41 so that a first image I1 and a second image I2 for forming a third image I3 to be a next frame image included in the moving image are generated and stored into the memory 2.

The CPU of the control unit 1 repeatedly performs the above respective pieces of processing until determining that instruction for completing the capturing of the moving image of the subject has been input, at step S42 (step S42: YES).

Meanwhile, when the CPU of the control unit 1 determines that the instruction for completing the capturing of the moving image of the subject has been input, at step S42 (step S42: YES), the storage control unit 6 acquires and associates the first image group G1, the second image group G2, and the composition position list L temporarily stored in the memory 2, and stores the associated first image group G1, second image group G2, and composition position list L into the second storing unit 207 (step S43).

Accordingly, the video shooting processing is completed.

### <Playback Processing>

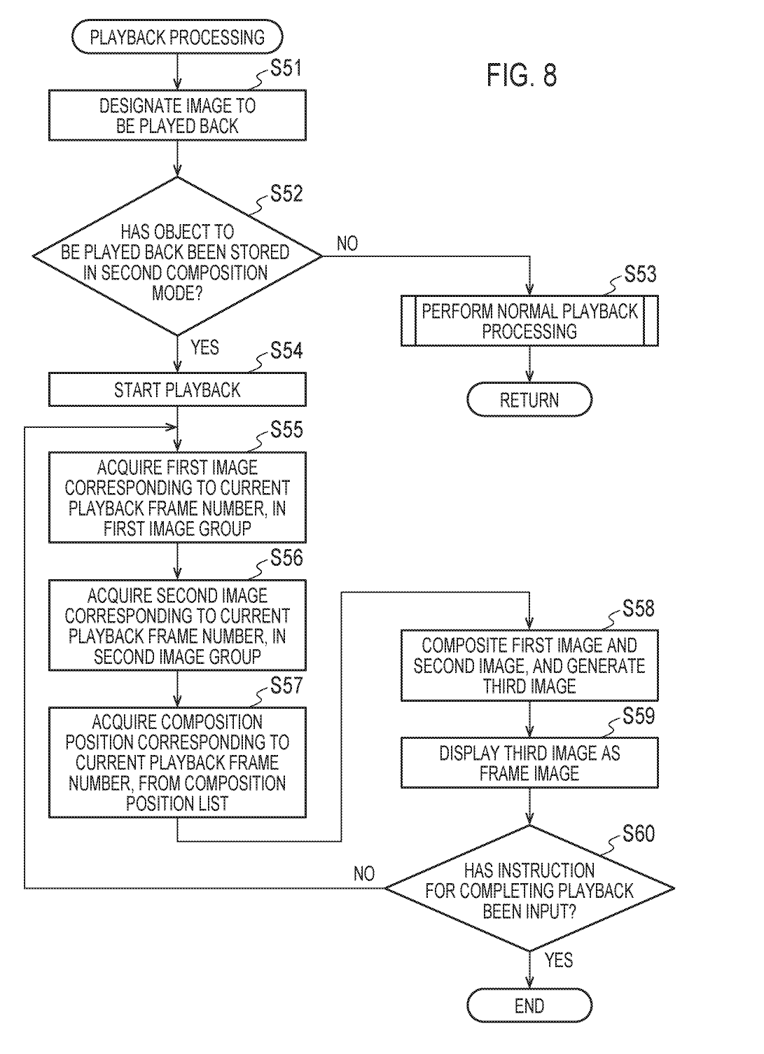

Next, playback processing performed by the image capturing apparatus 200, will be described with reference to FIGS. 8 to 9D.

FIG. 8 is a flow chart of exemplary operation according to the playback processing. FIGS. 9A to 9D are views for describing the playback processing.

As illustrated in FIG. 8, when the first image I1 or the second image I2 corresponding to the first frame number is designated to be an object to be played back, for example, based on the predetermined operation of the operation input unit 9 performed by the user (step S51), the CPU of the control unit 1 determines whether the object to be played back is an image stored in the second composition mode (refer to FIG. 7) (step S52).

Here, when determining that the object to be played back is not the image stored in the second composition mode (step S52: NO), the CPU of the control unit 1 performs normal playback processing, such as the above playback processing according to the first embodiment (refer to FIGS. 5A to 5C) (step S53).

Meanwhile, when the CPU of the control unit 1 determines that the object to be played back is the image stored in the second composition mode, at step S52 (step S52: YES), a display unit 8 starts playing back the designated moving image (step S54).

That is, the storage control unit 6 decodes a first image I1 corresponding to a current playback frame number, out of the first image group G1 stored in the second storing unit 207, using a decoding method corresponding to the compression format (for example, an MPEG format), and outputs the first image I1 to the memory 2. Then, the first acquiring unit 5c acquires YUV data of the first image I1 from the memory 2 (step S55). Next, the storage control unit 6 decodes a second image I2 corresponding to the current playback frame number, out of the second image group G2 stored in the second storing unit 207, using a decoding method corresponding to the compression format (for example, an MPEG format), and outputs the second image I2 to the memory 2. Then, the second acquiring unit 5d acquires YUV data of the second image I2 from the memory 2 (step S56). After that, the second compositing unit 205e acquires a composition position corresponding to the current frame number, from the composition position list L stored in the second storing unit 207 (step S57).

Note that, the above order of the respective pieces of processing at steps S55 to S57 is exemplary and the embodiment of the present invention is not limited to this. For example, the first image I1 may be acquired after the acquisition of the second image I2. In addition, the timing with which the composition position is acquired may be made before the acquisition of the first image I1 or the second image I2.

Next, the second compositing unit 205e composites the second image I2 to be superimposed on the composition position within the first image I1, generates and outputs YUV data of a third image I3 to a display control unit 8a (step S58). Then, the display control unit 8a displays, as a frame image, the input third image I3 on a display region of a display panel 8b at a predetermined playback frame rate (step S59, refer to FIG. 9A).

Next, the CPU of the control unit 1 determines whether an instruction for completing the playback of the moving image has been input (step S60), substantially, similarly to step S25 in the playback processing according to the above first embodiment.

Here, when determining that the instruction for completing the playback of the moving image has not been input (step S60: NO), the CPU of the control unit 1 makes the processing go back to step S55, and successively performs the respective pieces of processing from step S55. That is, the CPU of the control unit 1 performs the respective pieces of processing at steps S55 to S59 so that the third image I3 is generated, as the frame image, by the composition of the first image I1 and the second image I2 and the generated frame image is displayed, in playback frame number order (refer to FIGS. 9C and 9D).

Here, FIGS. 9A to 9D illustrate the exemplary moving image including, as a frame image, the third image I3 including the second image I2 generated with the size of the second area A2 gradually enlarging in accordance with the passage of image capturing time of the moving image, and the first image I1 composited.

The size of the first image I1 present on the outer side is gradually reduced in accordance with the enlargement of the size of the second image I2 present on the inner side in the exemplary moving image. During the process, when the second image I2 with the second area A2 gradually enlarging becomes larger than the size of the first image I1 gradually reducing, the second compositing unit 205e sets the second image I2 to be on the inner side and the first image I1 to be on the outer side, and composites the second image I2 and the first image I1 so as to generate the third image I3 (refer to FIG. 9C). Then, as illustrated in FIG. 9D, finally, the region of the portion of the first image I1 corresponding to the first frame number is displayed on the inner side of the second image I2 displayed over the display panel 8b.

The CPU of the control unit 1 repeatedly performs the above respective pieces of processing until determining that the instruction for completing the playback of the moving image has been input, at step S60 (step S60: YES).

When determining that the instruction for completing the playback of the moving image has been input, at step S60 (step S60: YES), the CPU of the control unit 1 completes the playback processing.

As described above, the image capturing apparatus 200 according to the second embodiment, can, for example, composite the second area A2 specified corresponding to the specific subject S (a notice portion), as the second image I2 having higher resolving power, with the first image I1, and then can generate the third image I3, substantially, similarly to the above first embodiment, and differently from a case where composition and display are performed with the region of the portion of the first image I1 simply enlarging. Thus, the composite third image I3 can be effectively utilized in the storage and the playback of the third image I3.

Particularly, the generated first image I1 and second image I2 are associated and stored in the second storing unit 207 during the shooting of the subject. Thus, the third image I3 is generated by compositing the first image I1 and the second image I2 stored in the second storing unit 207, and the third image I3 can be displayed, during the playback of the image. That is, there is no need to generate the third image I3 by the composition of the first image I1 and the second image I2 during the shooting of the subject. Thus, even the apparatus having relatively low throughput can individually, efficiently perform the shooting of the subject and the generation of the third image I3. Furthermore, the first image I1 is set to be present on the side outer than the second image I2 and a plurality of the third images I3 is generated. In addition, when the second image I2 with the size of the second area A2 gradually enlarging becomes larger than the size of the first image I1 gradually reducing, the second image I2 is set to be present on the side outer than the first image I1 and the plurality of the third images I3 can be also generated. Individually performing the shooting of the subject and the generation of the third image I3 can generate the third image I3 including the first image I1 and the second image I2 composited, in a mode in which flexibility is relatively high.

That is, according to the second embodiment, even when small storage capacity is provided, the shot image can be stored in a form in which approximate ascertainment of the entirety and detailed ascertainment of the notice portion can be made, similarly to the first embodiment. In comparison to the first embodiment, although management of storing and playing back the first image I1 and the second image I2 individually, is required, playback display utilizing the first image I1 including the entire original image I0 reduced and the second image I2 corresponding to the cut-out notice portion, can improve the flexibility in making the approximate ascertainment of the entirety and the detailed ascertainment of the notice portion.

Note that, the present invention is not limited to the above first and second embodiments. Various improvements and design alterations may be made without departing from the scope of the spirit of the present invention.

For example, in shooting the moving image, varying a position of the region of the portion cut out from the original image I0 by the second generating unit 5b may generate the second image I2 including a position of the second area A2 varied. That is, in a case where a plurality of the specific subjects S is present, the second generating unit 5b generates the second image I2 which is the position of the second area A2 varied so that composition can be made with the plurality of the specific subjects S switching, during the shooting of the moving image.

Furthermore, varying the number of the second areas A2 in accordance with the number of the specific subjects S, may generate a plurality of the second images I2 corresponding to each of the specific subjects S, and may composite the plurality of the second images I2 with the first image I1.

According to each of the above first and second embodiments, the plurality of the third images I3 is generated as the plurality of frame images included in the moving image. However, the case is exemplary and the embodiments of the present invention are not limited to this. For example, one still image may be provided.

The configurations of the image capturing apparatuses 100 and 200 exemplified in the above first and second embodiments, respectively, are exemplary. The embodiments of the present invention are not limited to these. Furthermore, each of the image capturing apparatuses 100 and 200 has been exemplified as an image processing apparatus. The embodiments of the present invention are not limited to these. Whether an image capturing function is provided, can be appropriately, arbitrarily changed.

In addition, in the above embodiments, a configuration in which the control of the control unit 1 drives the first acquiring unit 5c, the second acquiring unit 5d, and the first compositing unit 5e so as to achieve functions as the first acquiring means, the second acquiring means, and the compositing means, has been made. The embodiments of the present invention are not limited to this. A configuration in which the CPU of the control unit 1 executes, for example, a predetermined program so as to achieve the functions, may be provided.

That is, the program including a first acquisition processing routine, a second acquisition processing routine, and a composition processing routine, is stored in a program memory (not illustrated). The first acquisition processing routine may make the CPU of the control unit 1 achieve a function for acquiring the first image I1 which is the first area A1 of the subject displayed with the first resolving power. The second acquisition processing routine may make the CPU of the control unit 1 achieve a function for acquiring the second image I2 which is the second area A2 smaller than the first area A1 of the subject, displayed with the second resolving power higher than the first resolving power. The composition processing routine may make the CPU of the control unit 1 achieve a function for generating the third image I3 including the acquired first image I1 and the acquired second image I2 composited with the respective pieces of resolving power remaining.

Similarly, the CPU of the control unit 1 may execute, for example, a predetermined program so as to achieve the image capturing means, the first generating means, the second generating means, the first storing means, the second storing means, the playback means, and a storage control means.

Furthermore, ROM, a hard disk, nonvolatile memory, such flash memory, or a portable storage medium, such a CD-ROM, can be applied as a computer-readable medium storing the programs for performing the above respective pieces of processing. A carrier wave is also applied as a medium that provides data of the programs through a predetermined communication line.

The embodiments of the present invention have been described. The scope of the present invention is not limited to the embodiments described above, and includes the scope of the invention described in the scope of the claims and the scope of equivalents thereof.

The invention described in the scope of the claims first attached to the present application request is added below. The item numbers of the claims described in the addition conform to the scope of the claims first attached to the present application request.

In the embodiments described above, the control unit operates based on the programs stored in a storing unit so as to achieve (perform, include) the entirety or part of the various functions (processing, means) necessary for acquiring the various effects described above. However, the case is exemplary, and other various methods can be used in order to achieve the functions.

For example, an electronic circuit, such as an IC or an LSI, may be used to achieve the entirety or the part of the various functions. In this case, a person skilled in the art, can easily achieve a specific configuration of the electronic circuit, based on the flow charts and the function block diagrams described in the present specification, and thus the details will be omitted (for example, a configuration in which a comparator compares input data, and a selector is switched based on a result of the comparison, can be made for determination processing having a branch in the processing illustrated in each of the flow charts).

The plurality of functions (processing, means) necessary for acquiring the various effects may be freely divided, and an example will be described.

1. An image processing method by an image processing apparatus, comprising:
acquiring a first image which is a first area of a subject displayed with first resolving power;
acquiring a second image which is a second area smaller than the first area of the subject, displayed with second resolving power higher than the first resolving power; and
generating a third image by compositing the first image and the second image with the first resolving power and the second resolving power remaining.

2. The image processing method according to claim 1, further comprising:
capturing an image of an entire area to be shot of the subject, with predetermined resolution by an image capturing unit;
generating the first image by setting the entire image captured by the image capturing unit to be the first area and reducing the image of the first area; and
generating the second image by setting a region of a portion of the image captured by the image capturing unit to be the second area and cutting out an image of the second area.

3. The image processing method according to claim 2, further comprising:
generating the first image and the second image from the same image captured with the predetermined resolution by the image capturing unit, individually.

4. The image processing method according to claim 2, further comprising:
storing, after the third image is generated by compositing the first image and the second image, the third image into a storing unit, during shooting of the subject.

5. The image processing method according to claim 2, further comprising:
storing, after the first image and the second image are associated, the first image and the second image into a storing unit, during shooting of the subject; and
displaying, after the third image is generated by compositing the first image and the second image stored in the storing unit, the third image, during playback of an image.

6. The image processing method according to claim 2, further comprising:
capturing a moving image of the subject by the image capturing unit;
generating the first image from each of a plurality of frame images included in the moving image;
generating the second image from each of the plurality of frame images included in the moving image; and
generating the third image by compositing the first image and the second image corresponding to each other for each of the plurality of frame images included in the moving image.

7. The image processing method according to claim 6, further comprising:
generating the second image with the size of the second area varying for each of the plurality of frame images included in the moving image.

8. The image processing method according to claim 7, further comprising:
generating a plurality of the third images with a plurality of the second images generated with the size of the second area gradually enlarging; and
playing back a moving image including the plurality of the generated third images as a plurality of frame images, with the size of the second area gradually enlarging.

9. The image processing method according to claim 8, further comprising:
generating the plurality of the third images with the first image made to be on a side outer than the second image; and
generating the plurality of the third images with the second image made to be a side outer than the first image when the second image including the size of the second area gradually enlarging becomes larger than the size of the first image gradually reducing.

10. The image processing method according to claim 6, further comprising:
generating the second image with a position of the second area varied, as a frame image included in the moving image.

11. The image processing method according to claim 1, further comprising:
storing, after the third image generated by compositing the first image and the second image is compressed, the third image into a storing unit.

12. An image processing apparatus comprising:
a control unit configured to:
acquire a first image which is a first area of a subject displayed with first resolving power;
acquire a second image which is a second area smaller than the first area of the subject, displayed with second resolving power higher than the first resolving power; and
composite the first image and the second image with the first resolving power and the second resolving power remaining so as to generate a third image.

13. The image processing apparatus according to claim 12, further comprising:
an image capturing unit configured to capture an image of an entire area to be shot of the subject, with predetermined resolution, wherein
the control unit is configured to:
set the entire image captured by the image capturing unit to be the first area;
generate the first image with the image of the first area reduced;
set a region of a portion of the image captured by the image capturing unit to be the second area; and
cut off an image of the second area so as to generate the second image.

14. The image processing apparatus according to claim 13, wherein
the control unit is configured to generate the first image and the second image individually from the same image captured with the predetermined resolution by the image capturing unit.

15. The image processing apparatus according to claim 13, wherein
the control unit is configured to:
composite the first image and the second image so as to generate the third image; and
store the third image into a storing unit, during shooting of the subject.

16. The image processing apparatus according to claim 13, wherein
the control unit is configured to:
associate and store the first image and the second image, into a storing unit, during shooting of the subject;
composite the first image and the second image stored in the storing unit so as to generate the third image; and
display the third image, during playback of an image.

17. The image processing apparatus according to claim 13, wherein
the control unit is configured to:
use the image capturing unit so as to capture a moving image of the subject;
generate the first image from each of a plurality of frame images included in the moving image;
generate the second image from each of the plurality of frame images included in the moving image; and
composite the first image and the second image corresponding to each other for each of the plurality of frame images included in the moving image, so as to generate the third image.

18. The image processing apparatus according to claim 12, wherein
the control unit is configured to:
compress the third image generated by the composition of the first image and the second image, and
store the third image into a storing unit.

19. A non-transitory computer-readable storage medium storing a program for causing a computer of an image processing apparatus to execute:
processing of acquiring a first image which is a first area of a subject displayed with first resolving power;
processing of acquiring a second image which is a second area smaller than the first area of the subject, displayed with second resolving power higher than the first resolving power; and
processing of generating a third image by compositing the first image and the second image with the first resolving power and the second resolving power remaining.
